(19) United States
(12) Patent Application Publication
(10) Pub. No.: US 2004/0078479 A1
(43) Pub. Date: Apr. 22, 2004

(54) Traffic generator using a network processor

(76) Inventors: Chee Keong Sim, Serendah (MY); Deivakumar Rajasingam, Seremban (MY); Chong Chye Mah, Petaling Jaya (MY); Kenny Lai Kian Puah, Bukit Mertajam (MY)

Correspondence Address: KENYON & KENYON (SAN JOSE), 333 WEST SAN CARLOS ST., SUITE 600, SAN JOSE, CA, 95110, US

(21) Appl. No.: 10/262,276

(22) Filed: Sep. 30, 2002

(51) Int. Cl. G06F 15/16

(52) U.S. Cl. 709/236

(57) ABSTRACT

A system and a method for transmitting packets of data with a network processor in a variety of formats are disclosed. A sub-processor processes a set of data for transmission by a transmit engine across a transmission medium. The transmit engine receives the data set from the sub-processor through a transmit memory buffer. Information about the data set is stored with control information in a random access memory. The transmission speed is adjustable by the sub-processor. A receive engine receives data packets from the transmission medium and stores the data packets in a receive memory buffer. The sub-processor dumps the data into a file, either on command of the user or as determined by a program run on the sub-processor. Statistical data about the transmission and reception are stored in a statistic data memory buffer.

### BACKGROUND INFORMATION

The present invention relates to network processors. More specifically, the present invention relates to a method of allowing network processors to operate using a variety of formats.

Network processors are often used to process data on a network line. Among the functions that network processors perform is the transformation of a data set into a network format that allows the data set to be transmitted across a network. A network format usually involves breaking up the data set to be separated into a set of packets. In some formats, the packets are of equal size, and in other formats, the size can be varied.

The packets also have header information appended to the front of the packets. The header information can include format identification, packet group identification to keep the packet with the other packets created from the data set, packet order to allow reassembly in the proper order, and some form of error notification or correction. The header information can also include the destination of the packet as well as routing information. The network format can be any known format, including asynchronous transfer mode (ATM; Multiprotocol Over ATM, Version 1.0, July 1998), ATM Adaptation Layer 2 (AAL2; ITU-T recommendation I.363.2, −B-ISDN ATM adaptation layer type 2 specification,” Toronto, Canada, 1997), etc.

The network processor may have to service a variety of networks, with a variety of network formats. Furthermore, different networks may require different transmission speeds. Current network processors often have difficulty switching between the various formats and transmission speeds.

### BRIEF DESCRIPTION OF THE DRAWINGS

FIG. 1 provides an illustration of one possible embodiment of a processor according to the present invention.

FIG. 2 provides in a block diagram an illustration of one possible embodiment of the interaction between the sub-processor and the micro-engine according to the present invention.

FIG. 3 describes in a flowchart one possible embodiment of the processes for transmitting a data packet according to the present invention.

FIG. 4 describes in a flowchart one possible embodiment of the processes for receiving a data packet according to the present invention.

### DETAILED DESCRIPTION

A system and a method for transmitting packets of data with a network processor in a variety of formats are disclosed. In one possible embodiment, a sub-processor may process a set of data for transmission by a transmit engine across a transmission medium. The transmit engine may receive the data set from the sub-processor through a transmit memory buffer. The information about the data set may be stored with control information in a random access memory. The transmission speed may be adjustable by the sub-processor. A receive engine may receive data packets from the transmission medium and store the data packets in a receive memory buffer. The sub-processor may dump the data into a file, either on command of the user or as determined by a program run on the sub-processor, for example. Statistical data about the transmission and reception may be stored in a statistic data memory buffer.

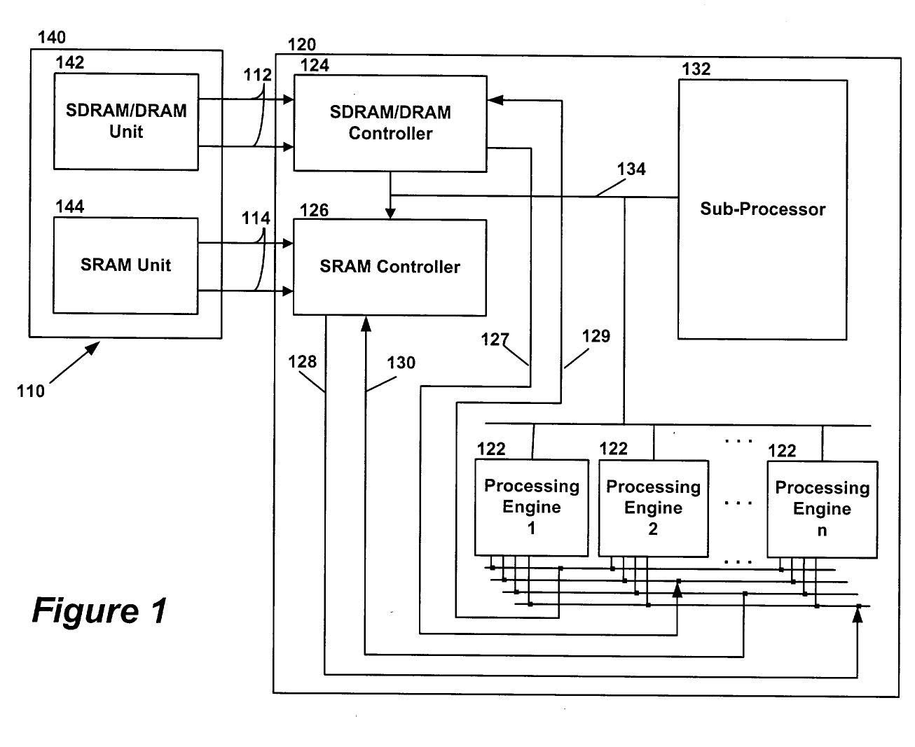

FIG. 1 is a block diagram of a processing system, in accordance with an embodiment of the present invention. In FIG. 1, a computer processor system 110 may include a parallel, hardware-based multithreaded network processor 120 coupled by a pair of memory buses 112, 114 to a memory system or memory resource 140. Memory system 140 may include a synchronous dynamic random access memory (SDRAM) unit 142 and a static random access memory (SRAM) unit 144. The processor system 110 may be especially useful for tasks that can be broken into parallel subtasks or operations. Specifically, hardware-based multithreaded processor 120 may be useful for tasks that require numerous simultaneous procedures rather than numerous sequential procedures. Hardware-based multithreaded processor 120 may have multiple microengines or processing engines 122 each processing multiple hardware-controlled threads that may be simultaneously active and independently worked to achieve a specific task.

Processing engines 122 each may maintain program counters in hardware and states associated with the program counters. Effectively, corresponding sets of threads may be simultaneously active on each processing engine 122.

In FIG. 1, in accordance with an embodiment of the present invention, multiple processing engines 1-n 122, where (for example) n=8, may be implemented with each processing engine 122 having capabilities for processing m hardware threads, (for example) m=8. The eight processing engines 122 may operate with shared resources including memory resource 140 and bus interfaces. The hardware-based multithreaded processor 120 may include a SDRAM/dynamic random access memory (DRAM) controller 124 and a SRAM controller 126. SDRAM/DRAM unit 142 and SDRAM/DRAM controller 124 may be used for processing large volumes of data, for example, processing of network payloads from network packets. SRAM unit 144 and SRAM controller 126 may be used in a networking implementation for low latency, fast access tasks, for example, accessing look-up tables, core processor memory, and the like.

In accordance with an embodiment of the present invention, push buses 127, 128 and pull buses 129, 130 may be used to transfer data between processing engines 122 and SDRAM/DRAM unit 142 and SRAM unit 144. In particular, push buses 127, 128 may be unidirectional buses that move the data from memory resource 140 to processing engines 122 whereas pull buses 129, 130 may move data from processing engines 122 to their associated SDRAM/DRAM unit 142 and SRAM unit 144 in memory resource 140.

In accordance with an embodiment of the present invention, eight processing engines 122 may access either SDRAM/DRAM unit 142 or SRAM unit 144 based on characteristics of the data. Thus, low latency, low bandwidth data may be stored in and fetched from SRAM unit 144, whereas higher bandwidth data for which latency is not as important, may be stored in and fetched from SDRAM/DRAM unit 142. Processing engines 122 may execute memory reference instructions to either SDRAM/DRAM controller 124 or SRAM controller 126.

In accordance with an embodiment of the present invention, the hardware-based multithreaded processor 120 also may include a sub-processor 132 for loading microcode control for other resources of the hardware-based multithreaded processor 120. In this example, sub-processor 132 may have an XScale™-based architecture manufactured by Intel Corporation of Santa Clara, Calif. A processor bus 134 may couple sub-processor 132 to SDRAM/DRAM controller 124 and SRAM controller 126.

The sub-processor 132 may perform general purpose computer type functions such as handling protocols, exceptions, and extra support for packet processing where processing engines 122 may pass the packets off for more detailed processing such as in boundary conditions. Sub-processor 132 may execute operating system (OS) code. Through the OS, sub-processor 132 may call functions to operate on processing engines 122. Sub-processor 132 may use any supported OS, such as, a real time OS. In an embodiment of the present invention, sub-processor 132 may be implemented as an XScale™ architecture, using, for example, operating systems such as VXWorks® operating system from Wind River International of Alameda, Calif.; μ C/OS operating system, from Micrium, Inc. of Weston, Fla., etc.

Advantages of hardware multithreading may be explained in relation to SRAM or SDRAM/DRAM accesses. As an example, an SRAM access requested by a thread from one of processing engines 122 may cause SRAM controller 126 to initiate an access to SRAM unit 144. SRAM controller 126 may access SRAM memory unit 126, fetch the data from SRAM unit 126, and return data to the requesting processing engine 122.

During a SRAM access, if one of processing engines 122 had only a single thread that could operate, that one processing engine would be dormant until data was returned from the SRAM unit 144.

By employing hardware thread swapping within each of processing engines 122 the hardware thread swapping may enable other threads with unique program counters to execute in that same processing engine. Thus, a second thread may function while the worker may await the read data to return. During execution, the second thread accesses SDRAM/DRAM unit 142. In general, while the second thread may operate on SDRAM/DRAM unit 142, and the first thread may operate on SRAM unit 144, a third thread, may also operate in a third one of processing engines 122. The third thread may be executed for a certain amount of time until it needs to access memory or perform some other long latency operation, such as making an access to a bus interface. Therefore, processor 120 may have simultaneously executing bus, SRAM and SDRAM/DRAM operations that are all being completed or operated upon by one of processing engines 122 and have one more thread available to be processed.

The hardware thread swapping may also synchronize completion of tasks. For example, if two threads hit a shared memory resource, for example, SRAM memory unit 144, each one of the separate functional units, for example, SRAM controller 126 and SDRAM/DRAM controller 124, may report back a flag signaling completion of an operation upon completion of a requested task from one of the processing engine threads. Once the processing engine executing the requesting thread receives the flag, the processing engine may determine which thread to turn on.

In an embodiment of the present invention, the hardware-based multithreaded processor 120 may be used as a network processor. As a network processor, hardware-based multithreaded processor 120 may interface to network devices such as a Media Access Control (MAC) device, for example, a 10/100BaseT Octal MAC device or a Gigabit Ethernet device (not shown). In general, as a network processor, hardware-based multithreaded processor 120 may interface to any type of communication device or interface that receives or sends a large amount of data. Similarly, computer processor system 110 may function in a networking application to receive network packets and process those packets in a parallel manner.

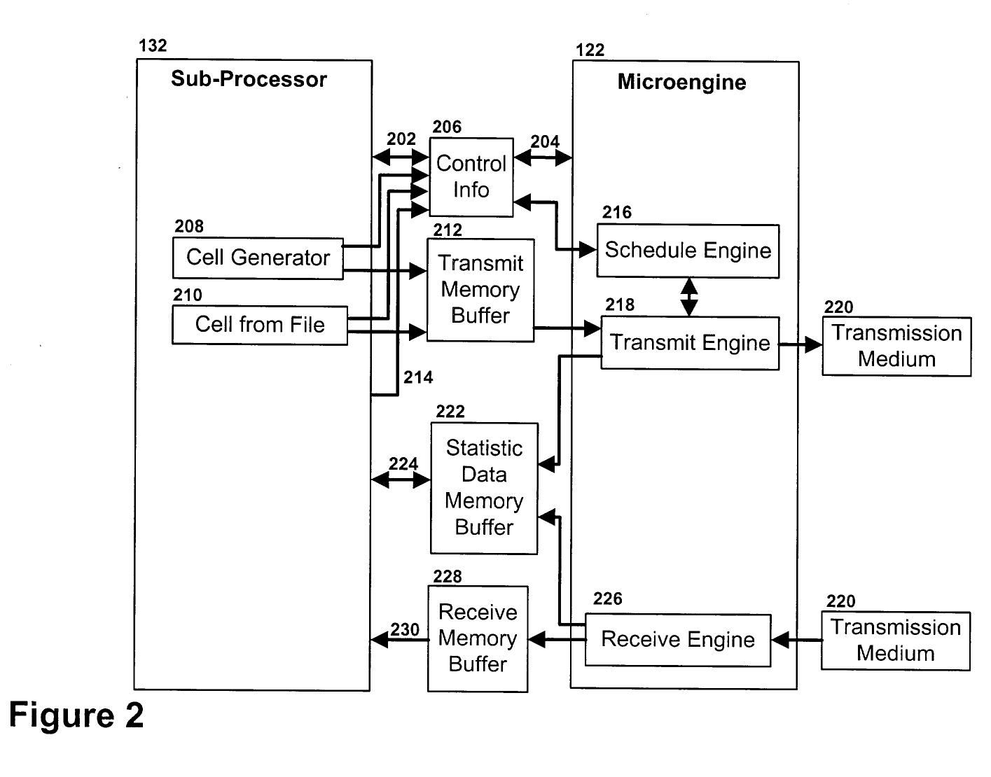

One possible embodiment of the interaction between the sub-processor 132 and a micro-engine 122 is illustrated in the block diagram of FIG. 2. The sub-processor 132 is coupled to a micro-engine 122 via signal lines 202 and 204 and a control information storage device 206. The control information storage device may be a random access memory (RAM) or other device (e.g. as part of memory resource 140). Control information may include initialization information, synchronization information, packet information, and transmission speed. The sub-processor 132 may initialize and synchronize the micro-engine 122 by storing the initialization and synchronization information in the control information storage device via signal line 202. Additionally, the micro-engine 122 may initialize and synchronize the sub-processor 132 by storing the initialization and synchronization information in the control information device via signal line 202. The sub-processor 132 may generate packets or, in the case of ATM transmissions, cells using a cell generator component 208. The cells or packets may be read from a file 210. These packets may then be stored in the transmit memory buffer 212. The packet information and transmission speed information 214 may be stored with the control information 206 in the RAM. A schedule engine 216 may read the control information 206 for the packet to be transmitted, transferring the control information 206 to a transmit engine 218. The schedule engine 216 may schedule a transmit engine 218 to transmit the packet on the transmission medium 220, the transmit engine 218 reading the packet from the transmit memory buffer 212. The transmission medium 220 can be a wire, a fiber optic or other transmission medium. The transmission speed of the transmit engine 218 can be adjusted during transmission by changing the transmission speed information 214 stored with the control information 206. Upon transmission, statistical data about the transmission may be recorded in the statistic data memory buffer 222. The sub-processor 132 may read the statistical data, via signal line 224, from the statistic data memory buffer 222, resetting the statistic data memory buffer 222 when necessary. By performing the pre-transmission processing in the sub-processor 122 and using the micro-engine 122 for transmitting, the network processor can easily switch between a plurality of network formats. Signal lines 202, 204, 224, and 230 may be part of the processor bus 134 in one embodiment. In one embodiment, memory devices 206, 212, 222, and 228 may be part of the memory unit 140.

A receive engine 226 may receive a packet over the transmission medium 220. The receive engine 226 may store the packets in a receive memory buffer 228. The sub-processor 132 may dump, via signal line 230, the contents of buffer 228 into a host machine file. Upon reception, statistical data about the reception may be recorded in the statistic data memory buffer 222. The sub-processor 132 may read the statistical data 224 from the statistic data memory buffer 222, resetting the statistic data memory buffer 222 when necessary.

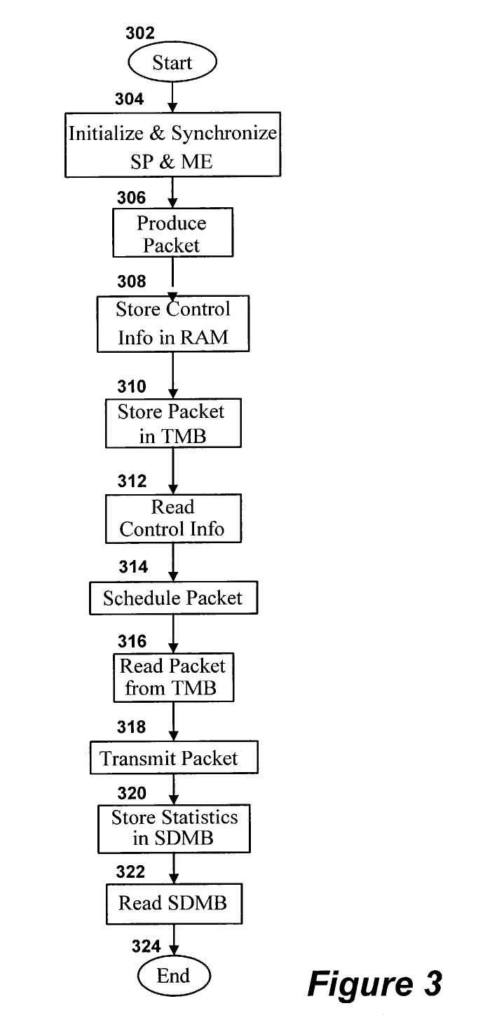

FIG. 3 describes in a flowchart one possible embodiment of the processes for transmitting a data packet. The process starts (Block 302) by initializing and synchronizing the sub-processor (SP) 132 and the micro-engines (ME) 122 (Block 304). The sub-processor then produces a packet (Block 306). Control information may then be stored in RAM (Block 306). The packet is stored in a transmit memory buffer (TMB) 212 (Block 310). A schedule engine (SE) 216 reads the control information (Block 312) and schedules the packet (Block 314). The transmit engine (TE) 218 then reads the packet from the transmit memory buffer (Block 316) and transmits the packet (Block 318). Statistical data about the transmission may be stored in the statistic data memory buffer (SDMB) 222 (Block 320), which is then read by the sub-processor 132 (Block 322) at the end of the process (Block 324).

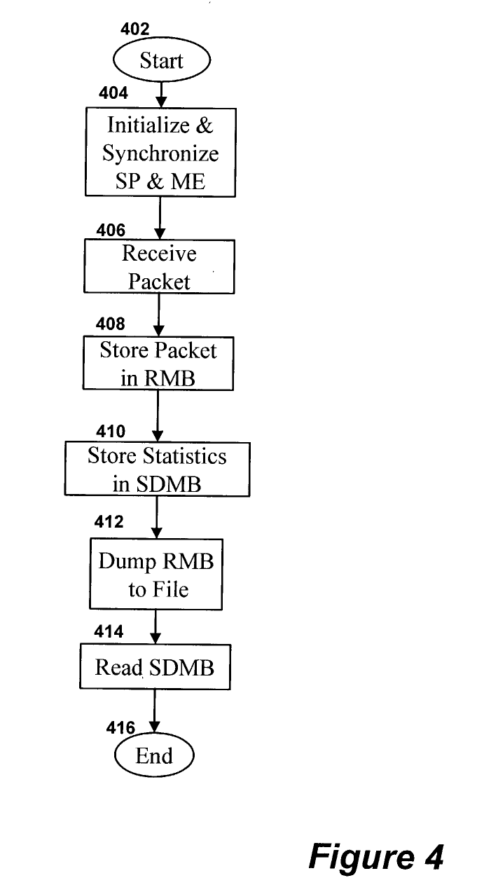

FIG. 4 describes in a flowchart one possible embodiment of the processes for receiving a data packet. The process starts (Block 402) by initializing and synchronizing the sub-processor (SP) 132 and the micro-engines (ME) 122 (Block 404). The receive engine (RE) 226 receives a data packet from the transmission medium 220 (Block 406). The packet is then stored in a receive memory buffer (RMB) 212 (Block 408). Statistical data about the receipt of the packet are stored in the statistic data memory buffer (SDMB) 222 (Block 410). The sub-processor 132 then dumps the receive memory buffer to a data file (Block 412). In one possible embodiment, the receive memory buffer 228 is dumped when the sub-processor 132 determines that the transmission has been completed. Alternately, the user may direct the sub-processor 132 to dump the receive memory buffer 228. In another possible embodiment, the receive memory buffer 228 is dumped when the buffer 228 is full. The statistic data memory buffer is read by the sub-processor 132 (Block 414) at the end of the process (Block 416).

Although several embodiments are specifically illustrated and described herein, it will be appreciated that modifications and variations of the present invention are covered by the above teachings and within the purview of the appended claims without departing from the spirit and intended scope of the invention. What is claimed is:

1. A system, comprising:
a sub-processor to perform pre-transmission processing of a first set of data to be transmitted across a transmission medium according to one of a plurality of network formats; and
a transmit micro-engine to transmit the first set of data across the transmission medium.

2. The system of claim 1, further comprising a transmitter memory buffer to store the processed first set of data for retrieval by the transmit micro-engine.

3. The system of claim 2, further comprising a random access memory to store control information for the transmit micro-engine.

4. The system of claim 3, further comprising a control micro-engine to read the control information from the random access memory.

5. The system of claim 4, wherein the control micro-engine is to schedule the first set of data for transmission by the first micro-engine.

6. The system of claim 1, further comprising a receive micro-engine to receive a second set of data from the transmission medium.

7. The system of claim 6, further comprising a receive memory buffer to store the second set of data for retrieval by the sub-processor.

8. The system of claim 6, further comprising a statistic memory buffer to store statistical information produced by the transmit engine and the receive engine.

9. The system of claim 1, wherein the first set of data is generated by the sub-processor.

10. The system of claim 1, wherein the first set of data is read from a file.

11. The system of claim 1, wherein the sub-processor sets a speed for transmission by the transmit engine before transmission.

12. The system of claim 1, wherein the sub-processor sets a speed for transmission by the transmit engine during transmission.

13. A method, comprising:
performing with a sub-processor pre-transmission processing of a first set of data to be transmitted across a transmission medium according to one of a plurality of network formats; and
performing with a transmit micro-engine only transmission of the first set of data across the transmission medium.

14. The method of claim 13, further comprising storing the processed first set of data for retrieval by the transmit micro-engine.

15. The method of claim 14, further comprising storing control information for the transmit micro-engine.

16. The method of claim 15, further comprising reading with a control micro-engine the control information from the random access memory.

17. The method of claim 16, further comprising scheduling with the control microengine the first set of data for transmission by the first micro-engine.

18. The method of claim 13, further comprising receiving with a receive micro-engine a second set of data from the transmission medium.

19. The method of claim 18, further comprising storing the second set of data for retrieval by the sub-processor.

20. The method of claim 18, further comprising storing statistical information produced by the transmit engine and the receive engine.

21. The method of claim 13, further comprising generating the first set of data in the sub-processor.

22. The method of claim 13, further comprising reading the first set of data from a file.

23. The method of claim 13, further comprising setting a speed for transmission by the transmit engine before transmission using the sub-processor.

24. The method of claim 13, further comprising setting a speed for transmission by the transmit engine during transmission using the sub-processor.

25. A set of instructions residing in a storage medium, said set of instructions capable of being executed by a processor to implement a method for processing data, the method comprising:
performing with a sub-processor pre-transmission processing of a first set of data to be transmitted across a transmission medium according to one of a plurality of network formats; and
performing with a transmit micro-engine only transmission of the first set of data across the transmission medium.

26. The set of instructions of claim 25, wherein the method further comprises storing the processed first set of data for retrieval by the transmit micro-engine.

27. The set of instructions of claim 26, wherein the method further comprises storing control information for the transmit micro-engine.

28. The set of instructions of claim 27, wherein the method further comprises reading with a control micro-engine the control information from the random access memory.

29. The set of instructions of claim 28, wherein the method further comprises scheduling with the control micro-engine the first set of data for transmission by the first micro-engine.

30. The set of instructions of claim 25, wherein the method further comprises receiving with a receive micro-engine a second set of data from the transmission medium.

31. The set of instructions of claim 30, wherein the method further comprises storing the second set of data for retrieval by the sub-processor.

32. The set of instructions of claim 30, wherein the method further comprises storing statistical information produced by the transmit engine and the receive engine.

33. The set of instructions of claim 25, wherein the method further comprises generating the first set of data in the sub-processor.

34. The set of instructions of claim 25, wherein the method further comprises reading the first set of data from a file.

35. The set of instructions of claim 25, wherein the method further comprises setting a speed for transmission by the transmit engine before transmission using the sub-processor.

36. The set of instructions of claim 25, wherein the method further comprises setting a speed for transmission by the transmit engine during transmission using the sub-processor.
